(19) United States
(12) Patent Application Publication
(10) Pub. No.: US 2014/0032247 A1
(43) Pub. Date: Jan. 30, 2014

(54) CLAIMS-UNDERWRITING INTEGRATION SYSTEM AND METHOD

(71) Applicants: Kenneth C. Robinson, Wauwatosa, WI (US); Jonathan E. Kost, Waterford, WI (US); Marc-Olivier Huynh, Montreal (CA); Andrew Justman, Genesee, WI (US)

(72) Inventors: Kenneth C. Robinson, Wauwatosa, WI (US); Jonathan E. Kost, Waterford, WI (US); Marc-Olivier Huynh, Montreal (CA); Andrew Justman, Genesee, WI (US)

(73) Assignee: SYMBILITY SOLUTIONS INC., TORONTO (CA)

(21) Appl. No.: 13/952,339

(22) Filed: Jul. 26, 2013

Related U.S. Application Data
(60) Provisional application No. 61/676,074, filed on Jul. 26, 2012.

(51) Int. Cl. G06Q 40/08

(52) U.S. Cl. CPC G06Q 40/08
USPC 705/4

(57) ABSTRACT

Methods and systems electronically integrate a claims workflow management system and a claim handling application with a property records system.

### CROSS-REFERENCE TO RELATED APPLICATIONS

This application claims priority to and the benefit of U.S. Provisional Application No. 61/676,074, filed on Jul. 26, 2012.

### STATEMENT REGARDING FEDERALLY SPONSORED RESEARCH

Not applicable.

### FIELD OF THE DISCLOSURE

This application relates to a system and method for integrating insurance systems and more specifically to a system and method for electronically integrating a claims workflow management system and a claim handling application with a property records system.

### BACKGROUND

Companies, such as insurance companies or carriers, separately use a variety of tools or systems (e.g., software programs, web-based applications, administrative tools, workflow management systems, etc.) throughout the insurance ecosystem. For example, a company may use a first system for evaluating and adjusting insurance claims. Separately, the company may use a second system for valuation of a property (e.g., residential or commercial) to aid in underwriting an insurance policy on the property and/or collect property characteristic records.

### SUMMARY OF THE INVENTION

The disclosure provides methods and systems for providing an improved claims-handling and underwriting data collection process.

In one embodiment, a method of providing an improved claims-handling process comprises a) Creating a claim file, b) Contacting a property records system, c) Updating the claim file with information from the property records system, d) Downloading the claim file into a claim handling application, and e) Updating the property records system with information received during the claim process; wherein an improved claims-handling and underwriting data collection process is provided.

Other objects, features and advantages of the present disclosure will become apparent after review of the attached appendix, specification, claims and drawings.

### BRIEF DESCRIPTION OF THE FIGURES

The present disclosure is illustrated and described herein with references to various figures, in which:

FIG. 1 is a diagram of the improved process of the present disclosure.

FIG. 2 is a diagram of the improved process of the present disclosure according to another implementation.

FIG. 3 is a diagram of the improved process of the present disclosure according to another implementation.

FIG. 4 is a diagram of the improved process of the present disclosure according to another implementation.

FIG. 5 is a diagram of the improved process of the present disclosure according to another implementation.

FIG. 6A is a diagram of a claim estimate with no pre-fill data according to one implementation.

FIG. 6B is a diagram of a claim estimate that includes pre-fill data according to another implementation.

FIG. 7 is a diagram of different materials that can be chosen for a specific type of repair or new construction by the program according to one implementation.

FIG. 8 is a sectional view of a wall and a roof, showing the different materials that are included in an estimate for repair or new construction according to one implementation.

FIG. 8A is a diagram illustrating an example prefill form for user input on a replacement project.

FIGS. 9A, 9B and 9C are diagrams of a visual representation of an process selecting the appropriate predetermined data listings, materials to complete the repair or new construction according to one implementation.

### DETAILED DESCRIPTION

Before the present materials and methods are described, it is understood that this invention is not limited to the particular methodology, protocols, materials, and processes described, as these may vary. It is also to be understood that the terminology used herein is for the purpose of describing particular embodiments only, and is not intended to limit the scope of the present invention which will be limited only by any later-filed non-provisional applications.

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, and “having” can be used interchangeably.

Unless defined otherwise, all technical and scientific terms used herein have the same meanings as commonly understood by one of ordinary skill in the art to which this invention belongs. Although any systems and methods similar or equivalent to those described herein can be used in the practice or testing of the present disclosure, the preferred methods and materials are now described.

In various exemplary embodiments, the present disclosure provides methods and systems for providing an improved claims-handling process.

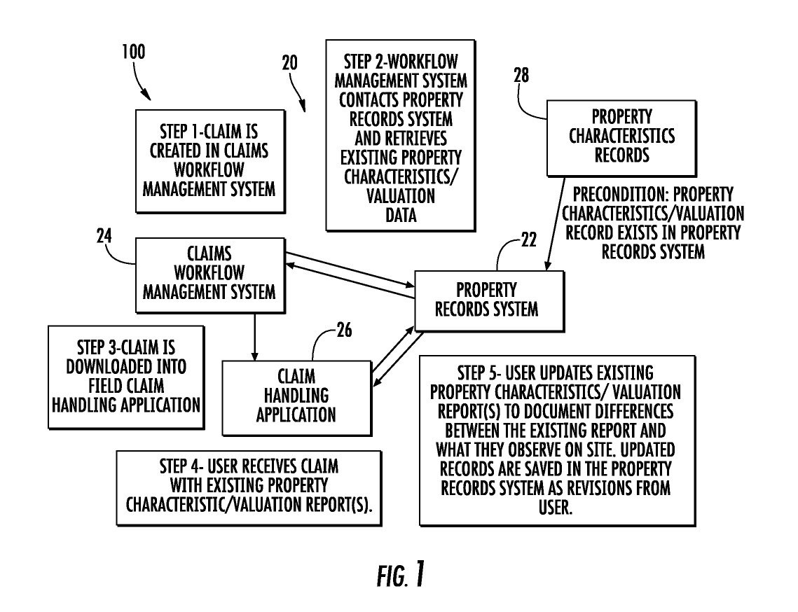

FIG. 1 schematically illustrates an example claim handling system 20. As will be described hereafter, claim handling system 20 electronically integrates a claims workflow management system and a claim handling application with a property records system. Claim handling system 20 comprises, property records system 22, claims workflow management system 24 and claim handling application 26.

Property records system 22 is comprised of a computerized or digital records system containing records 28 of different properties. When referring to property records system 22, any relevant databases could be accessed; which generally include but are not limited to, databases containing general or specific property characteristics, building historical database, building cost databases, property contents databases and other collector databases. Property records system 22 could also include but is not limited to data from databases referring to weather data, previous insurance claims, property construction and improvement history, and demographic or firmographic data. Such records 28 form a database of property characteristics as well as valuations for the individual real estate properties. Property records system 22 is configured to electronically or digitally transmit information from such records to claims workflow management system 24 and claim handling application 26. Property records system 22 is further configured to update such records with new information received from claims workflow management system 24 and/or claim handling application 26. In one implementation, property records system 22 comprises a server configured to retrieve and transmit information from such records to system 24 and application 26.

Claims workflow management system 24 comprises a computerized system of one or more processing units and memory configured to receive or generate a property damage claim for a property for insurance recovery or other purposes. Claims workflow management system 24 is configured to digitally communicate with property records system 22 across a local area network or a wide area network, such as Internet, to retrieve information for a property for which a claim has been received. As will be described hereafter, claims workflow management system 24 is further configured to generate a customized prefilled claim form based upon the information digitally retrieved from property records system 22. In one implementation, claims workflow management system 24 generates a customized prefilled claim form or template using predictive technologies which predict what information is needed to complete a property damage claim based upon the digitally retrieved property record information. Upon generation of the customized prefilled claim form or template, claims workflow management system 24 is configured to download or digitally transmit the former template to the claim handling application 26. In one implementation, claims workflow manager system 24 comprises a database and a digital server configured to communicate with claim handling application 26 across a local area network or a wide area network in a wired or wireless fashion. In one implementation, claims workflow management system 24 comprises one or more processing units configured to carry out instructions contained in a non-transient or non-transitory computer-readable medium to perform data retrieval from property records system 22, claim form customization and claim handling application transmissions. Alternatively, this process may be implemented in the claim handling application 26. If implemented in the claim handling application 26, modifications are needed to the upstream workflow or a new workflow is required to accommodate for this.

For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 92 may be embodied as part of one or more application-specific integrated circuits (ASICs). Unless otherwise specifically noted, the controller is not limited to any specific combination of hardware circuitry and software, nor to any particular source for the instructions executed by the processing unit.

Claim handling application 26 comprises a computer or electronic device utilized by claim adjusters, inspectors, inside adjusters, desk adjusters, and the like in the field or in the office when documenting information to deny or satisfy an insurance claim. In one implementation, claim handling application 26 comprises a portable electronic device such as a smart phone, laptop computer, tablet computer or other portable electronic device by which data may be manually or audibly input. In one implementation, claim handling application 26 comprises a display to visibly present information.

In the example illustrated, claim handling application 26 is configured to digitally communicate with property records system 22 and claims workflow manager system 24 in a wired or wireless fashion across a local area network or a wide area network. Claim handling application 26 comprises one or more processing units operating according to instructions contained in one or more non-transitory computer-readable mediums. Claim handling application 26 is configured to retrieve or receive the customized claim form or template from claims workflow management system 24. Claim handling application 26 is further configured to digitally transmit information received during the handling of a claim to property records system 22 such that property records system 22 may update records 28 using the information received from claim handling application 26. In one implementation, claim handling application 26 receives property information from claims workflow map system 24 or directly from property records system 22 and compare such received information with information manually or audibly input during the handling of a claim. Based upon such comparison, claim handling application 26 identifies differences and transmits differences, confirmations and unmodified data in such information to property records system 22. Such an implementation, the amount of information transmitted back to property records system 22 from claim handling application 26 is greatly reduced. In another implementation, claim handling application 26 may transmit the updated information or at least the identified differences in information to claims workflow management system 24, wherein claims workflow manager system 24 forwards the received property information or property information differences to property records system 22.

FIG. 1 further illustrates an example claim handling method 100 for being implementation by claim handling system 20. In Step 1, a claim file is created in a claims workflow management system. A “claims workflow management system” is defined as any system known in the industry for handling or processing insurance claims; For example, the system may be an administrative claims management system. The claims workflow management system may be implemented, in one example, as a web-based application; however, other implementations are possible. The claims workflow management system may also be an application program interface (API) and configured to provide a point of entry to an end user or system.

The claim file contains information related to a claim, such as general claim notes, details on the information captured at first notice of loss, details on the estimate and/or damage that has occurred to a property, or other appropriate information. For example, details on a first notice of loss may include information an insurance company adds to the claims workflow management system (e.g., either manually or via integration with their host system) when a claim file is created. Typically, this information includes address of the loss site (damaged property), contact information for the policyholder, a simple description of the damage and coverages, endorsements, and limits in the insurance policy.

In Step 2, the claims workflow management system contacts or otherwise interacts with a property records system. “Property records system” is defined as any system known in the industry including but not limited to the insurance, engineering, inspection, construction, appraisal and underwriting industries for providing property characteristic information (e.g., such as a property records database, either publicly available or privately assembled; an underwriting valuation system; etc.). Such systems include but are not limited to underwriting systems, appraiser data, tax assessments, permit history such as commercially available from BuildFax®, weather data, prior insurance loss data, inspection data, Marshall & Swift/Boeckh Interchange data and others. This interaction may be prefaced on a look up or query of the property records system based on any number of factors, such as but not limited to policy number, property address, policyholder name, etc.

Through the interaction with the property records system, current property characteristics can be input into the claim file and/or claims workflow management system. These property characteristics may be general in nature, or specific to the loss site address (e.g., specific house characteristics). In one implementation, the property characteristics are input into the claim file and/or claims workflow management system as individual data. In another implementation, the property characteristics may be part of a property valuation record that is produced by an underwriting valuation system. According to this implementation, the property valuation record may include replacement cost value number (e.g., based on a calculation by the underwriting valuation system) to be used by the claims workflow management system (or a part of the claims workflow management system or other separate system, such as a claim handling application as described below) or end user in facilitating the claims handling process. This property valuation record may be of any appropriate form (e.g., txt, xml, pdf, doc, jpeg, etc.).

Step 3 includes downloading the claim file from the claims workflow management system into a claim handling application. A “claim handling application” is defined as any application or system known in the respective industries for providing claim handling, estimations, job management or other services for estimating and inspection activities known in the respective industries. Whereas the claims workflow management system is intended to be a web-based application (although there is no need to be limited to such an application), the claim handling application is intended to be utilized on a smartphone, tablet, laptop, desktop computer, or other computing device (although there is no need to be limited to such a device). The downloading of the claim file may be a manual step, or may be automated, such as with a synchronizer, and may be carried out by an end user or other member or system in the insurance ecosystem.

In Step 4, a user of the claim handling application (e.g., a “user”) receives the claim file with the property characteristics and/or property valuation record received through integrating with the property records system. The user may include but is not limited to a field adjuster, inside adjuster, desk adjuster, (e.g., an insurance company adjuster or an independent adjuster), a contractor, or another user (e.g., an expert such as a water mitigation expert, engineer, policyholder, a supplier or other member of the supply chain, etc.).

The user may then act to work or handle the claim, or any portion of the claim, to facilitate the overall claims process. For example, an adjuster (or other user) may validate the property characteristics of the loss site (e.g., by visually comparing property characteristics of the loss site with those integrated into the claim file).

The user may also scope the damage of the loss site. This may entail diagramming and/or dimensioning the damaged area, introducing prices/materials for the damaged area into the claim file, completing a questionnaire about the structure and damaged area, and introducing photos, video or other details of the damaged area into the claim file.

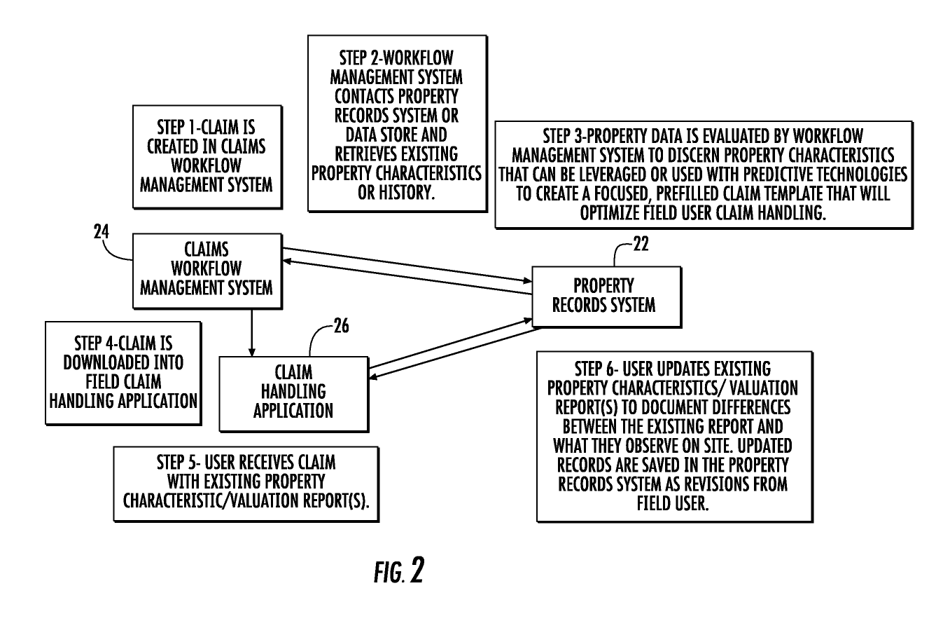

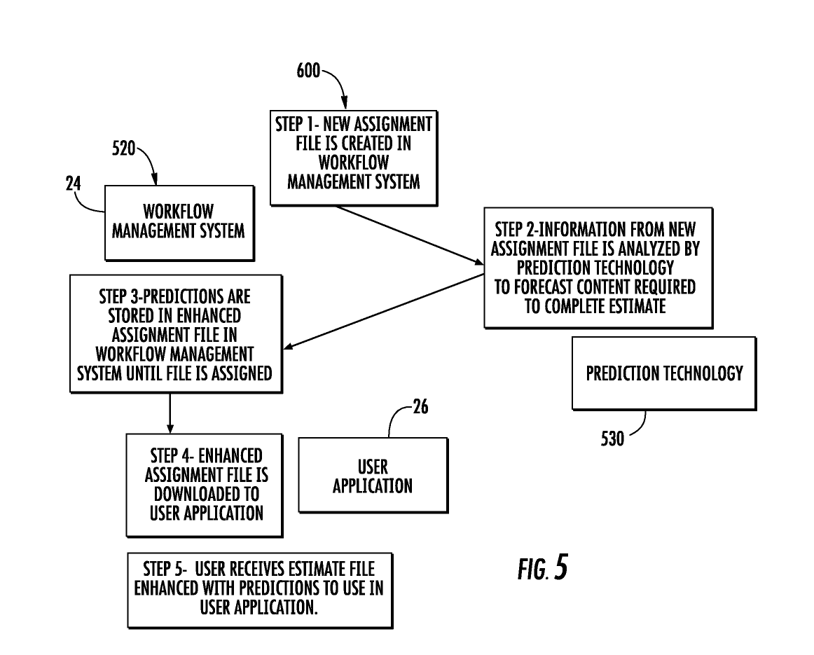

With respect to introducing scope, including diagrams and prices/materials for the damaged area into the claim file, this may be accomplished manually, semi-automatically, or automatically. For example, an adjuster (or other user) may manually search through a material cost sheet or database and pull the specific line item price/material information as needed. Alternatively, the adjuster (or other user) may pull a pre-determined batch or group of line items from the material cost sheet or database (e.g., for an entire wall, or room of a property). Still alternatively, as will be discussed in more detail below with reference to FIGS. 2 and 5, the claim file may be automatically pre-filled with specific scope details including but not limited to diagrams and line item price and material information as provided through integration with the property records system.

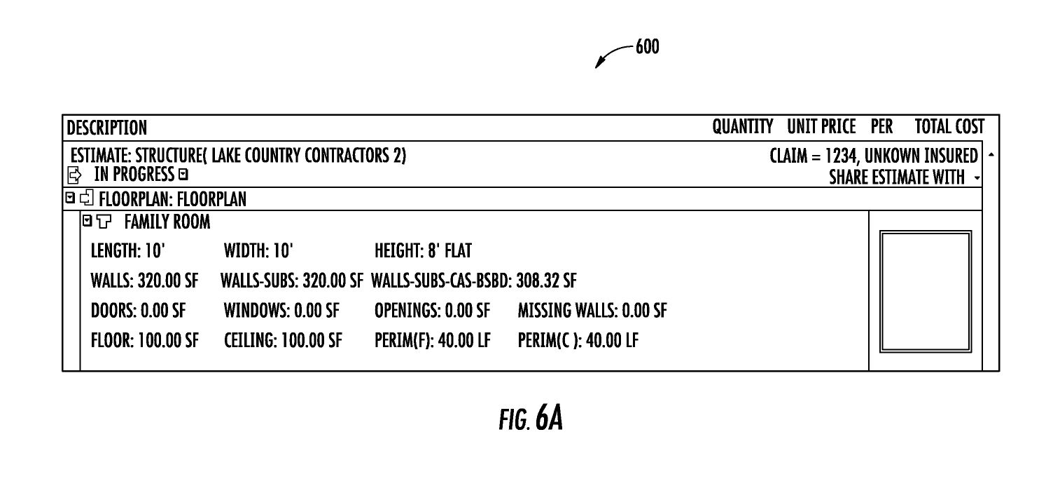

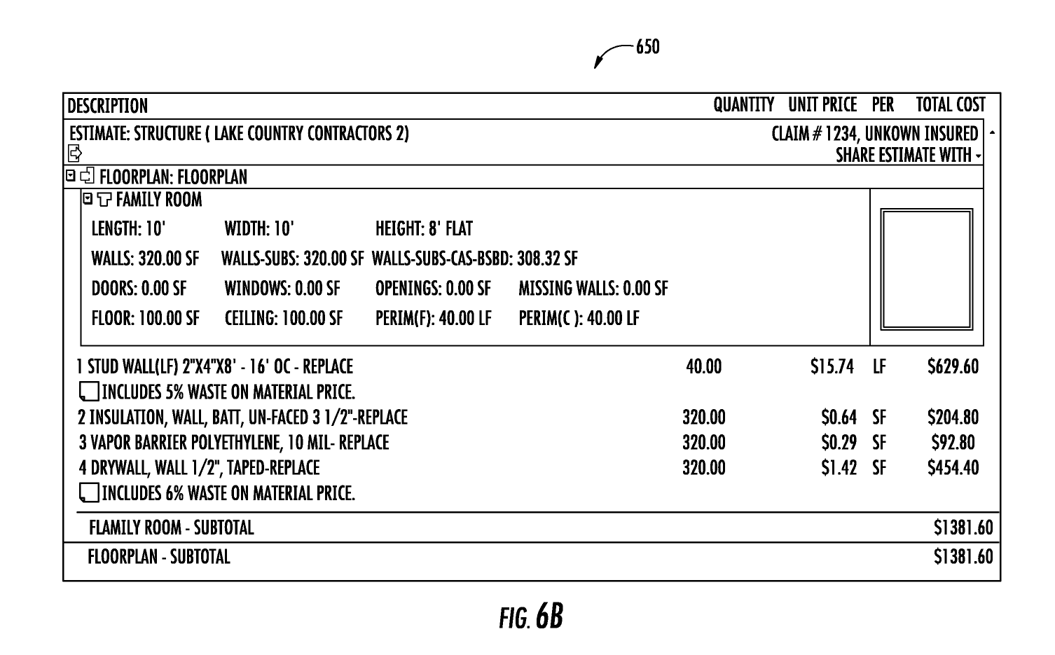

FIG. 6A is a graphical representation of an example claim form screen shot 600 which demonstrates how when a claim estimate does not have any pre-filled data, the majority of an employee's time is spent on inputting the data into the claim (the data that would need to be inputted is shown in FIG. 6B)—leaving less time to work with the customer, check compliance issues, or collaborate with all relevant parties.

FIG. 6B is a graphical representation of an alternative claim form screen shot 650, illustrating items that have been selected in processing a claim estimate for a standard exterior wall replacement with standard construction materials. The process automatically selects the standard materials needed for an exterior wall replacement or the new construction of an exterior wall. All of the materials selected by the process will be accompanied by pricing information from one or many material databases. The pre-fill option will save the user the time of inputting all or some of the data depending upon how much data the user has the process select automatically.

The number of items used in the pre-filled data or cost calculation may be automatically designated, semi-automatically designated or manually chosen.

As part of working/handling the claim, or a portion thereof, the adjuster (or other user) may also create (e.g., use the field estimating application tool or system to create) a report or series of reports to facilitate payment to the participants in the claim and/or repair process. For example, reports may be created or generated for the insurance company, the policy holder, contractors, etc.

According to other implementations, additional modules or tasks may be integrated into or used with the claim handling application. For example, but not limited to, these modules or tasks may include water mitigation, scheduling or project management, etc.

Referring now to Step 5, a user, including but not limited to contractors, inspectors, remodelers, adjusters, policyholders or other users, may document any differences between property characteristics observed at site where the loss was reported and the property characteristics provided by the property records system. This may be done by the user directly inputting updated property characteristics into the property records system. Such updates are then saved into the databases making up the property records system to be used for future actions. For example, updates may be used for insurance policy review or other actions. These updates or revisions may be saved with attribution to the claims user, for example, to determine who has made these updates or revisions. According to one implementation, the user works directly within the property records system (e.g., within an underwriting valuation system).

Other options to update the property records system may take the form of sending updated data or forms to the property records system, which are then used to manually or automatically update the property characteristics within the property records system.

For clarity, updating of the property records system by the user (or another) may occur at any step within the integration system once the original property characteristics are retrieved. Users could also include consumers/policyholders. For example, updating may occur anytime between Steps 2 and 5.

FIG. 5 illustrates claim handling system 520, another implementation of claim handling system 20. Claim handling system 520 is similar to claim handling system 20 except that claim handling system 520 comprises prediction technology 530. Prediction technology 530 comprises a set of instructions and logic contained on a non-transitory computer-readable medium that direct the one or more processing units of workflow management system to system 522 and forecasts content that is likely needed for completion of a claim, estimate or assignment. In one implementation, claim handling system 520 is not integrated with other external systems, such as property records system 22.

FIG. 5 further illustrates an example method 600 that may be carried out by claim handling system 520. As shown by FIG. 5, in Step 1 of method 600, a new assignment is created in the Workflow Management System. This may occur similar to as described above with respect to Step 1 of FIG. 1, or by an alternative method or process known in the industry.

In Step 2 of method 600, information from the new assignment file is analyzed by prediction technology. The information could include but is not limited to: type of damage or type work requested, location of property, property characterstics, and qualitative severity of damage. This analysis facilitates creation of a focused, pre-filled estimating template that optimizes user handling. This includes but is not limited to 1.) Limiting materials/price list to items that pertain to the exact structure and damage type, 2.) Adding details and estimate information to the claim file before the user receives a claim file to reduce the amount of information the user must enter to complete the claim—including floorplan and diagram elements and 3.) Use of predictive technologies to accomplish optimization of assignment files.

Prediction technologies represented in Step 2 include but are not limited to predictive models, logic tables and building component taxonomies. Refer to [0039] for additional description of predictive technologies.

In Step 3 of method 600, the predictions are stored in an enhanced assignment file in the Workflow Management system until the file is assigned to a user.

Step 4 of method 600 includes downloading the enhanced assignment file from the workflow management system into a field handling application. This may occur similar to as described above with respect to Step 3 of FIG. 1, or by an alternative method or process such as rendering the file in a web-based system.

FIG. 2 is a flow diagram illustrating method 200, an alternative method that may be carried out by claim handling system 20. In Step 1 of FIG. 2, a claim file is created in a claims workflow management system. This may occur similar to as described above with respect to Step 1 of FIG. 1, or by an alternative method or process known to the art.

In Step 2 of FIG. 2, the claims workflow management system contacts or otherwise interacts with another system or data store containing property records or information. Examples of these systems and data stores include but are not limited to: Underwriting systems, appraiser data, tax assessments, permit history like BuildFax®, weather data, prior insurance loss data, inspection data, building characteristic databases such as Marshall & Swift/Boeckh's Interchange data database, “such as noted earlier.” This may occur similar to as described above with respect to Step 2 of FIG. 1, or by an alternative method or process. Through the interaction with the system containing property records or information, current property characteristics and/or valuation data and/or other property data can be used to enhance the claim file and/or claims workflow management system.

In Step 3 of FIG. 2, the property characteristics data is evaluated by the workflow management system to discern specific property characteristics that can be chosen to create a focused, pre-filled claim template within the claim file to optimize user claim handling. Alternatively, this process may be implemented in the claim handling application 26. If implemented in the claim handling application 26, modifications are needed to the upstream workflow or a new workflow is required to accommodate for this. This includes but is not limited to 1.) Limiting materials/price list to items that pertain to the exact structure and damage type, 2.) Adding details and estimate information to the claim file before the user receives a claim file to reduce the amount of information the user must enter to complete the claim, and 3.) Use of predictive technologies to accomplish optimization of claim files. As explained before, this process is depicted in FIG. 6B.

Predictive technologies used in Step 3 can include but are not limited to processes that 1.) Predict estimate materials and characteristics based on the frequency of materials used in estimates, 2.) Predict estimate materials and characteristics (including floorplan characteristics) based on peril or damage type, property location (Address), property characteristics from external system (see for examples) and user input, 3.) Predict estimate materials and characteristics based on peril or damage type, property location (Address), property characteristics from external system (see [0032] for examples), 4.) Predict estimate materials and characteristics based on peril or damage type, property location (Address), property characteristics from external system (see for examples) and a building intelligence classification system, 5.) Peril and location information, and 6.) Other approaches that predict the contents of specific buildings based on dynamic scoring of criteria required to arrive at a prediction. This could include but is not limited to economic status of an area (net worth statistics and crime rates are examples), demographic information, and property type.

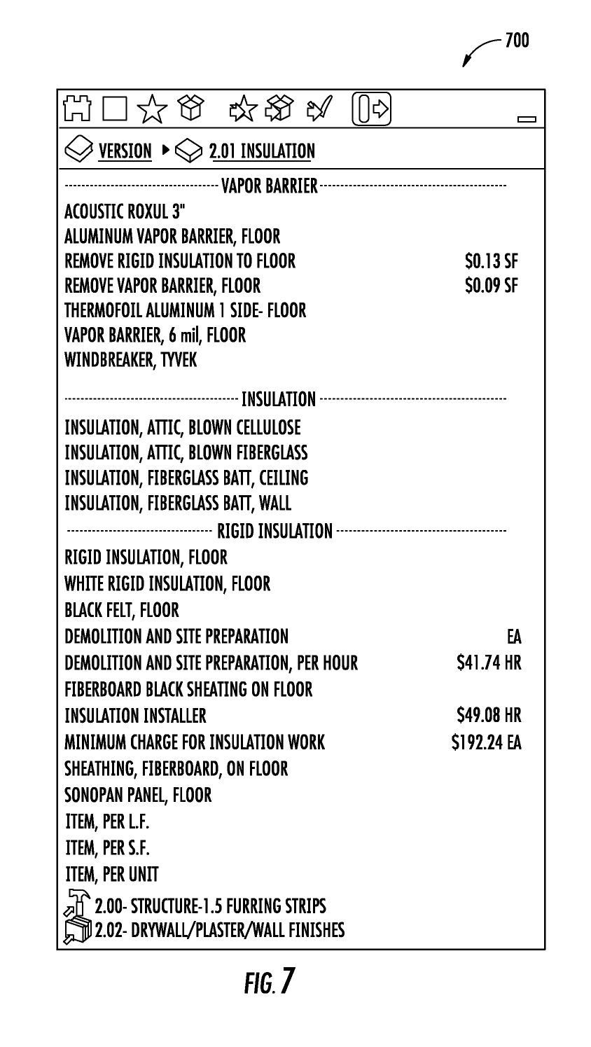

An example relating to processes that “1.) predict estimate materials and characteristics based on the frequency of materials used in estimates” is present in FIGS. 7, 8 and 9. FIG. 7 illustrates and example screen shot 700 of materials, demonstrating how the process selects the items most commonly used in the construction industry for the replacement of a specific kind of damaged property or new construction and then provides a detailed labor and material cost breakout for the specific geographic region designated by the user—which, in turn, saves the user both time and money.

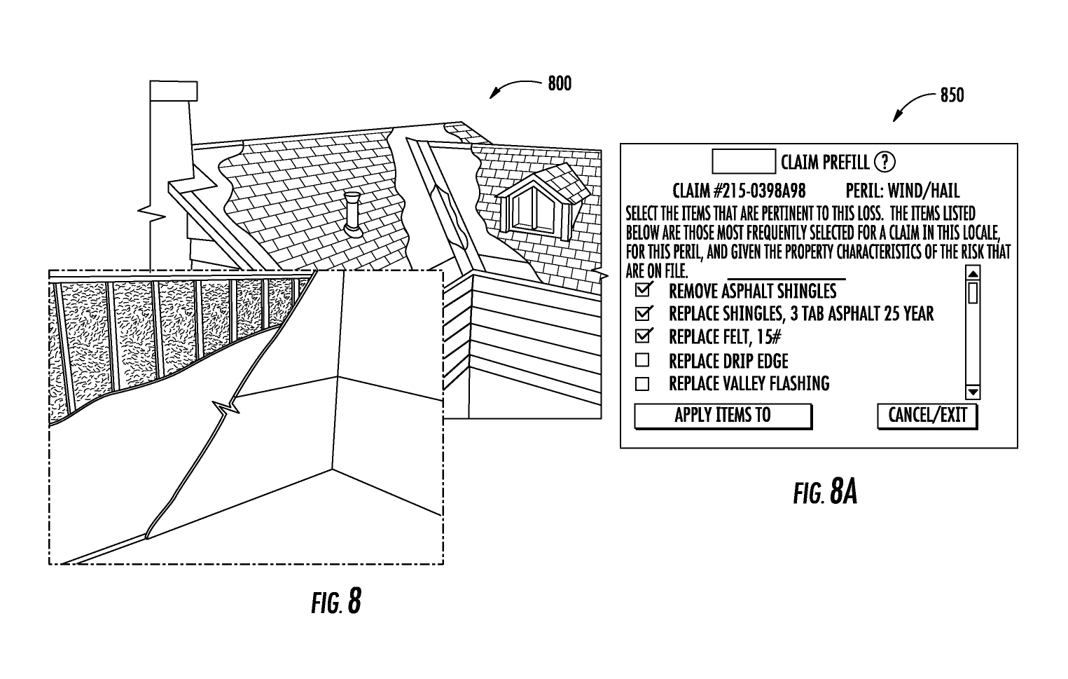

FIG. 8 illustrates fragmentary views of an exterior wall 800. FIG. 8 shows the various layers for a standard residential exterior wall: moisture barrier, insulation, wall framing, and drywall. In addition, FIG. 8 illustrates the different locations where ice and water shield is located on a standard roof.

As FIG. 7 demonstrated how the process selects the items most commonly used for a specific type of repair or new construction, the wall section 800 in FIG. 8 visually shows the different layers of a standard wall that the process will automatically select for repair of wall damage or new construction of a wall. The process will select the most commonly used materials in the industry for the specific task. In this example, the materials are a moisture barrier, insulation, wall framing and drywall. Accompanying the materials will be estimated pricing and estimated labor rates. The overall cost and production time will be dependent upon the input values, such as the size of the room that the user enters.

FIG. 8 also visually shows the different locations that ice & water shield is located on roofs. For example, if a roof suffered damage from a hail storm or a new roof was going to be constructed, the process would automatically select the standard materials used in a roof repair for hail damage (taking into account the specifics of the loss including location which would determine whether items like ice & water shield are common given the local climate and building practices). In this example, the materials the process would select include, but are not limited to, ice & water shield, roofing felt, flashing and shingles. When materials are selected by the process, pricing and production information will also be presented and made available to be added into the claim automatically. The process automatically selecting the standard industry materials will save the user time by having to input less data, which in turn, saves the user money.

FIG. 8A is an example screenshot 850 illustrating how system 24 automatically identifies and presents potential repair steps or procedures given the prior input information and then automatically prompts the user to select those repair procedures for inclusion in the claim or estimate.

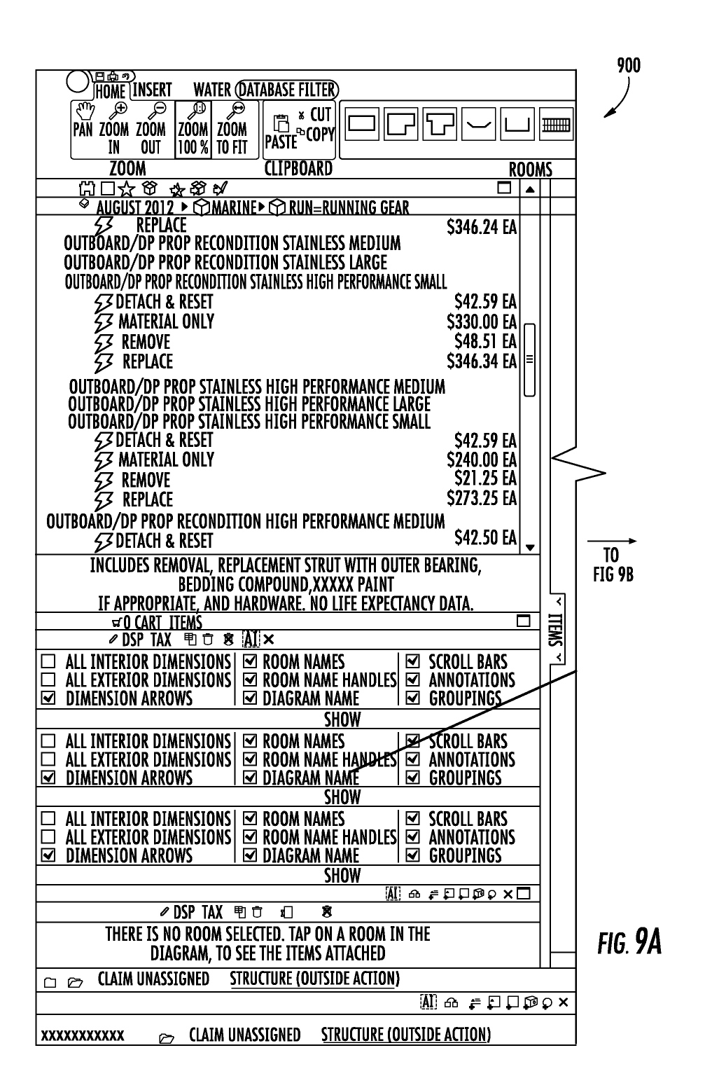

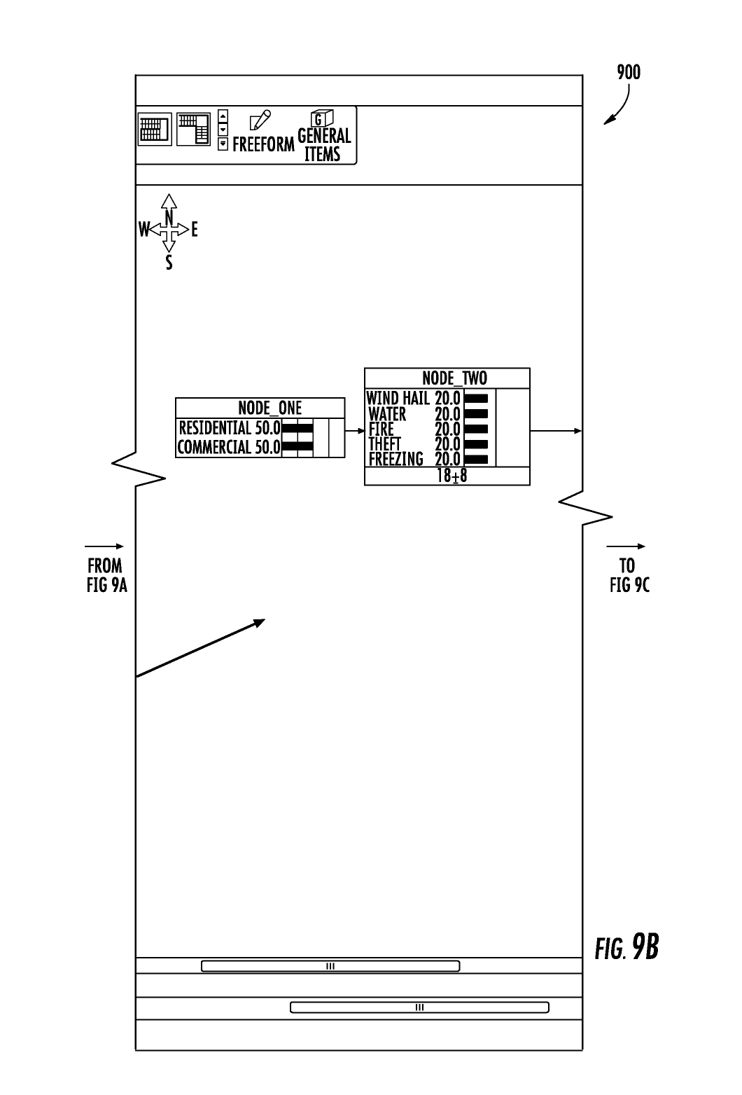

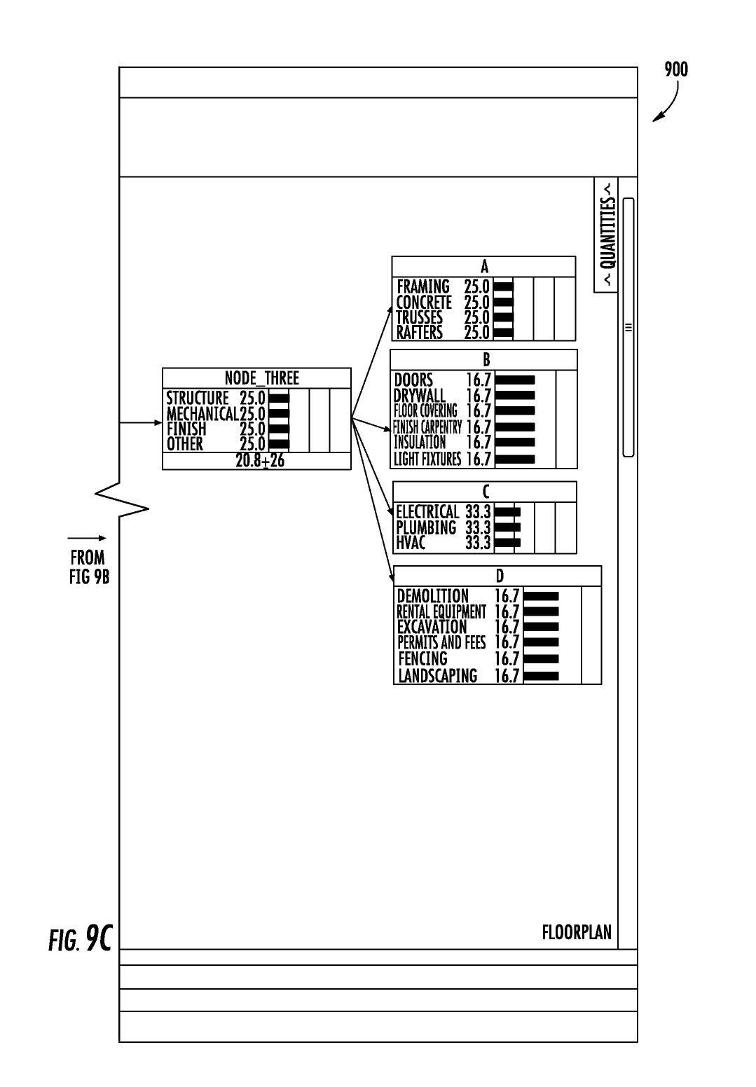

FIG. 9 is a visual representation of an example screenshot 900, illustrating how the process selects the appropriate items from the database and then automatically inserts them into the claim or file estimate as pre-filled data—which in turn saves the user both time and money.

The process models the property characteristics for a given property against a combination of data including but not limited to local pertinent building practices, historical loss information, and damage-ability in order to return the optimized prediction regarding the damage incurred in the loss.

In reference to FIG. 8, an example prediction could be that a brick home with asphalt shingle roof, when faced with damaging hail of a given size would require replacement of shingles, felt, ice & water shield, etc. whereas a home in the same area with aluminum siding and 24 gauge metal roof could predict replacement of siding, but not of roofing materials.

The result is that users receive a focused claim template that is optimized for speedy and efficient completion with a higher level of accuracy and consistency across all estimates.

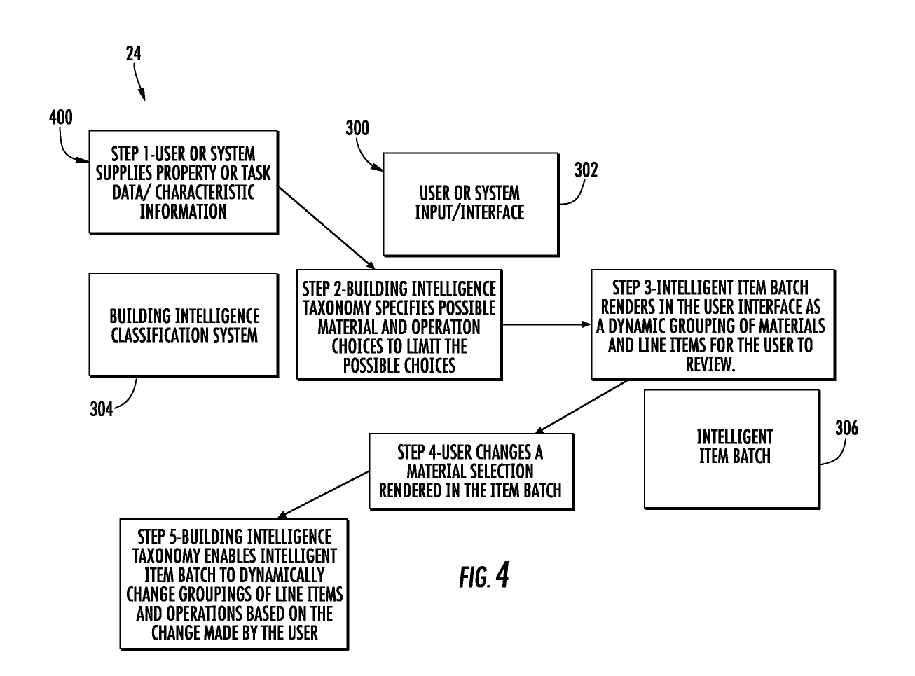

Referring now to FIG. 4, in some cases the optimized handling of focused claim templates can be realized by using predictions that include Intelligent Item batches. FIG. 4 schematically illustrates an example form or template building system 300 of claim handling application 26. Template building system 300 comprises inputs 302, building intelligence classification system 304 and intelligent item batch 306. Interface 302 comprises a device or component by which system or user input may be provided to system 26. In one implementation, interface 302 comprises a keyboard, a touchpad, touch screen, mouse, stylus, microphone and speech recognition software and the like. Interface 302 facilitates completion of the template or form. In one implementation an interface 302 may be provided at claims workflow management system 24 in addition or as an alternative to claim handling application 26.

Building intelligence classification system 304, used in claims workflow management system 24 and claim handling application 26, comprises one or more processing units and a non-transitory computer-readable medium containing instructions for directing the one or more processing units to modify or generate the template based upon materials and operation choices selected through interface 302. In one implementation, the template generated by workflow management system 24 is a dynamic set of graphical user interfaces and input prompts presented on display of claim handling application 26. The graphical user interfaces and input prompts of the template dynamically change, by category of material or the like, in claim handling application 26 in response to selections made using interface 302 and in response to instructions provided by building intelligence classification system 304 in claims workflow management system 24.

Intelligent item batch 306 comprises computer-readable instructions contained in a non-transient computer-readable medium for directing the generation of the template by building intelligence classification system 304. Intelligent item batch 306 may comprise a database of building classifications, material types or other specifications which are used to generate the template. Intelligent Item batches 306 use a building intelligence classification system to create dynamic groupings of materials and operations geared towards accomplishing construction of a building or part of a building. The building intelligence classification system is a taxonomy that defines typical/possible groupings of materials and operations and the way that they are typically assembled to accomplish a building construction or repair task. This framework allows users to view alternate materials that are logical substitutions for the material already presented to the user. For example, when creating an estimate for the roof, the taxonomy could offer users several options for types of shingles but would not offer carpet because that is not an item that should be used as a roof covering. The Intelligent Item batches can also be focused on a specific remodeling, maintenance or repair task. Intelligent Item batches tell the building intelligence classification system to change the items and operations presented to the user based on different material selections. This dynamic grouping of relevant materials and operations allows users to continue to use the technology even if the original predictions are not correct or not necessary.

FIG. 4 further illustrates a flow diagram of an example method 400 that is utilized by user or system input/interface 300. As indicated by step 1 of method 400, user system supplies property or task data/characteristic information using interface 302. As indicated by step 2 of method 400, building intelligence classification system utilizes building intelligence taxonomy to identify possible material and operation choices. As indicated by step 3 of method 400, intelligence item batch 306 receives information from building intelligence clarification system 304 and renders in the user interface or interface 302 a dynamic grouping of materials in light items for user to review is part of the claim handling application 26. As indicated by step 4 of method 400, based upon the list of options, a user may change a material selection displayed in the item batch on the interface 302. As indicated by step 5 of method 400, the groupings of line items and operations are dynamically changed by building intelligence classification system 304 in response to user input changes and in accordance with building intelligence taxonomy. Such changes are dynamically reflected in the graphical user interfaces and selection prompts presented on interface 302.

Step 4 of FIG. 2 includes downloading the claim file from the claims workflow management system into a claim handling application. This may occur similar to as described above with respect to Step 3 of FIG. 1, or by an alternative method or process such as rendering the file in a web-based system.

In Step 5 of FIG. 2, a user receives the claim file pre-filled with information as described in [0030]-[0034]. The user may then act to work or handle the claim, or any portion of the claim, to facilitate the overall claims process. However, the user in FIG. 2 has less information to search for and gather as compared to a user in FIG. 1 due to the pre-filled, optimized template, thus adding efficiency to the claims process of FIG. 2. The user may than complete any number of necessary tasks (e.g., as described above with reference to FIG. 1).

Referring now to Step 6 of FIG. 2, the user may document any differences between property characteristics observed at the site where loss was reported and the property characteristics provided in the enhanced, pre-filled claim file. The documentation may be done by the user directly inputting the updated property characteristics into the source property records system but could also manifest in other ways such as updating based on the contents of the claim file itself. Such updates are then saved into the property records system and/or workflow management system to be used for future actions. For example, updates may be used for insurance policy review, renewal processing, pricing, risk selection, rating changes, or other actions. These updates or revisions may be saved with attribution to the claims user, for example, to determine who has made these updates or revisions.

For clarity, updating of the property records system by the user (or another) may occur at any step within the integration system once the original property characteristics are retrieved. For example, updating may occur anytime between Steps 2 and 6.

One key advantage of the above systems and methods is to increase the productivity, accuracy, and efficiency of the overall claims process. One other key advantage is to increase the aggregation and validation of information for use in underwriting processes including renewal processing, risk selection, rating, etc. By decreasing the time required, costs incurred, and/or number of tasks to complete the claims and underwriting process, companies can benefit in a number of ways.

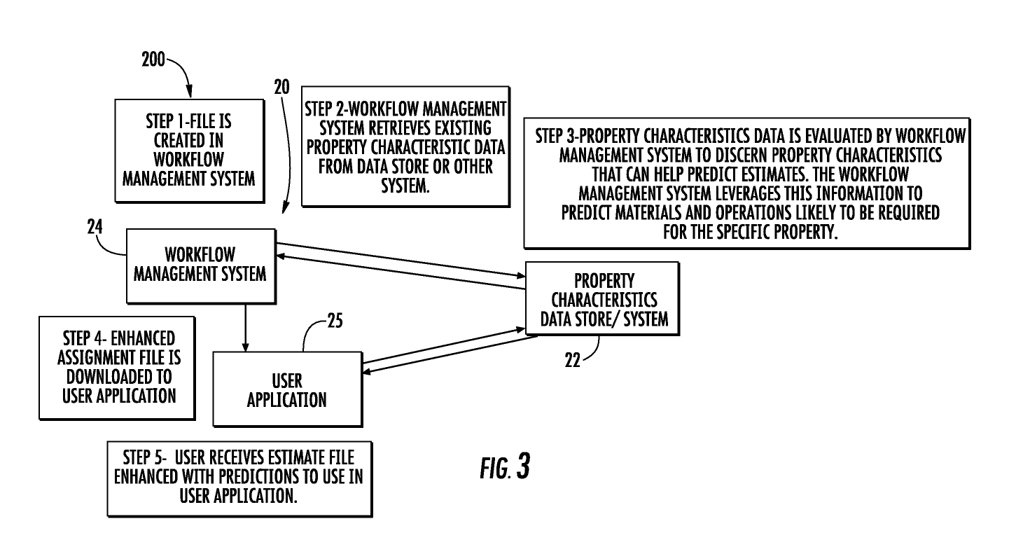

Referring now to FIG. 3, an alternative implementation of the integration system and method is shown. In Step 1 of FIG. 3, a new assignment file is created in a workflow management system. The new assignment file is similar to the described above with respect to Step 1 of FIG. 1, or by an alternative method or process known in the industry.

In Step 2 of FIG. 3, the workflow management system 24 contacts or otherwise interacts with another system or data store containing property records or information. Alternatively, this process may be implemented in the user application 25. If implemented in the user application 25, modifications are needed to the upstream workflow or a new workflow is required to accommodate for this. Examples of these systems and data stores include but are not limited to underwriting systems, appraiser data, tax assessments, permit history that is commercially available from BuildFax®, weather data, prior insurance loss data, inspection data, Marshall & Swift/Boeckh Interchange data and others. This Step could be similar to the described Step above with respect to Step 2 of FIG. 1, or by an alternative method or process. Through the interaction with the system containing property records or information, current property characteristics and/or valuation data and/or other property data can be used to enhance the claim file and/or claims workflow management system.

In Step 3 of FIG. 3, the property characteristics data is evaluated by the workflow management system to discern specific property characteristics that can be chosen to create a focused template to optimize user handling (typically inspection or estimating activities). This includes but is not limited to 1.) Limiting materials/price list to items that pertain to the exact structure and task-such as remodeling, property preservation/protection, repair or inspection, 2.) Adding information to the file before the user receives it to reduce the amount of information the user must enter to complete their task, and 3.) Use of predictive technologies to accomplish optimization of field activities.

Predictive technologies used in Step 3 can include but are not limited to processes that 1.) Predict estimate materials and characteristics based on the frequency of materials used in estimates, 2.) Predict estimate materials and characteristics (including floorplan characteristics) based on peril or damage type, property location (Address), property characteristics from external system and user input, 3.) Predict estimate materials and characteristics based on task type, property location (Address/locale), property characteristics from external system, 4.) Predict estimate materials and characteristics based on peril or damage type, property location (Address), property characteristics from external system and a building intelligence classification system, 5.) Peril and location information, and 6.) Other approaches that predict the contents of specific buildings based on dynamic scoring of criteria required to arrive at a prediction. This could include but is not limited to economic status of an area (net worth statistics and crime rates are examples), demographic information, and property type.

The result is that users receive a focused assignment template that is optimized for speedy and efficient completion with a higher level of accuracy and consistency regardless of user skill level and domain knowledge.

In some cases the optimized handling of focused task templates can be realized by using Intelligent Item batches. Intelligent Item batches use a building intelligence classification system to create dynamic groupings of materials and operations geared towards accomplishing construction of a building or part of a building. They can also be focused on a specific remodeling, maintenance, inspection or repair task. Intelligent item batches tell the classification system to change the items and operations presented to the user based on different material selections. This dynamic grouping of relevant materials and operations allows users to continue to use the technology even if the original predictions are not correct.

Step 4 of FIG. 3 includes downloading the assignment file from the workflow management system into a field or user-facing application. This may occur similar to as described above with respect to Step 3 of FIG. 1, or by an alternative method or process such as rendering the file in a web-based system or smartphone/tablet application.

In Step 5 of FIG. 3, a user receives the optimized assignment file pre-filled with information as described above. The user may then act to work or handle the claim, or any portion of the claim, to facilitate the overall claims process. However, the user in FIG. 3 has less information to search for and gather as compared to a user in FIG. 1 due to the pre-filled, optimized template, thus adding efficiency to the handling process depicted in FIG. 3. The user may than complete any number of necessary tasks (e.g., as described above with reference to FIG. 1).

Referring now to Step 6 of FIG. 3, the user may document any differences between property characteristics observed on site and the property characteristics provided in the enhanced, pre-filled assignment file. This may be done by the user directly inputting updated property characteristics into the source property records system but could also manifest in other ways such as updating the assignment file itself. Such updates are then saved into the property records system and/or workflow management system to be used for future actions. These updates or revisions may be saved with attribution to the user, for example, to determine who has made these updates or revisions.

For clarity, updating of the property records system by the user (or another) may occur at any step within the integration system once the original property characteristics are retrieved. For example, updating may occur anytime between Steps 2 and 6.

One key advantage of the above systems and methods is to increase the productivity, accuracy, and efficiency of the overall inspection/estimating/scoping or other building arts process. By decreasing the time required and/or number of tasks to complete this process, companies can benefit in a number of ways.

The aforementioned examples are offered for illustrative purposes only and are not intended to limit the scope of the present disclosure in any way. Indeed, various modifications of the invention in addition to those shown and described herein will become apparent to those skilled in the art from the foregoing description and the following examples and fall within the scope of the appended claims

While this invention has been described in conjunction with the various exemplary embodiments outlined above, various alternatives, modifications, variations, improvements and/or substantial equivalents, whether known or that are or may be presently unforeseen, may become apparent to those having at least ordinary skill in the art. Accordingly, the exemplary embodiments according to this invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents of these exemplary embodiments. All technical publications, patents and published patent applications cited herein are hereby incorporated by reference in their entirety for all purposes.

We claim:

1. A claims-handling method comprising:
a) creating a digital claim file;
b) digitally contacting a digitized property records system;
c) digitally updating the claim file with information digitally received from the property records system;
d) generating an industry based, pre-filled digital claim template based on the information digitally received from the property records system;
e) downloading the claim file into a claim handling application; and
f) digitally updating the property records system with information received during a.

2. The method of claim 1, wherein the digitized property records system comprises data selected from a group of data consisting of: underwriting system data, appraiser data, tax assessments, permit history, weather data, prior insurance loss data, inspection data, Marshall & Swift/Boeckh Interchange data.

3. The method of claim 1, wherein the claim file contacts a database in the property records system and wherein the property records system sends known address specific data from a database to the claim file.

4. The method of claim 1, wherein pre-filled claim templates are created using information sent from one or more databases with existing data in the property records systems to the claim file.

5. The method in claim 4 further comprising automatically digitally entering a pre-arranged group of items into the claim file for a certain peril or damage set in response to the creation of the digital claim file.

6. The method in claim 1 further comprising presenting claim specific data via a digital report.

7. The method of claim 1, wherein generating the industry based, pre-filled digital claim template further comprises using building intelligence classifications to dynamically group and present material and operation information to users.

8. A file-handling method for industries involving buildings comprising:
a) creating an optimized, pre-filled assignment file;
b) digitally contacting a property records system or data store;
c) digitally updating the assignment file with information from the property records system or data store;
d) modifying the assignment file based on predictive technologies to optimize user input and file handling;
e) downloading the assignment file into a field handling application; and
f) digitally updating the property records system with information received during a handling process.

9. The method of claim 8, wherein the property records system comprises data selected from a group of data consisting of: underwriting systems data, appraiser data, tax assessments, permit history such as commercially available from BuildFax®, weather data, prior insurance loss data, inspection data, Marshall & Swift/Boeckh Interchange data and others;

10. The method of claim 8, wherein the assignment file contacts a database in the property records system which then sends the known address specific data from the database to the claim file;

11. The method of claim 8, wherein pre-filled assignment templates are created using information sent from a database with existing data in the property records systems to the claim file.

12. The method of claim 8 further comprising using building intelligence classifications to dynamically group and present material and operation information to users.

13. A computer implemented claim handling system comprising:
a property records system comprising a digital record including a characteristic of a property;
a computerized claims workflow management system configured to:
digitally retrieve information for the property from the record of the property records system;
to generate a prefilled customized claim template based upon the retrieve information for the property; and
to digitally transmit the prefilled customized claim template to a claim handling application.

14. The computer implemented claim handling system of claim 13 further comprising the claim handling application, wherein the claim handling application is configured to digitally transmit update information to the property records system and wherein the property records system is configured to update the record based upon the update information.

15. The computer implemented claim handling system of claim 14, wherein the claim handling application is configured to compare information received from the property records system to obtained information during claim handling and to digitally transmit identified differences to the property records system.
